(19) United States
(12) Patent Application Publication
(10) Pub. No.: US 2010/0307600 A1
(43) Pub. Date: Dec. 9, 2010

(54) APPARATUS AND METHOD FOR AUTOMATICALLY DISABLING UTILITIES

(75) Inventor: Kevin M. Crucs, Copley, OH (US)

Correspondence Address: HAHN LOESER & PARKS, LLP, One GOJO Plaza, Suite 300, AKRON, OH, 44311-1076, US

(73) Assignee: CRUCS HOLDINGS, LLC, Copley, OH (US)

(21) Appl. No.: 12/823,171

(22) Filed: Jun. 25, 2010

Related U.S. Application Data
(63) Continuation-in-part of application No. 12/388,637, filed on Feb. 19, 2009.

(51) Int. Cl. F15C 3/00; F16K 31/12

(52) U.S. Cl. 137/2; 137/486

(57) ABSTRACT

A safety apparatus for automatically disabling a utility of a facility. The safety apparatus includes at least one remote sensor that transmits a signal if an environmental parameter reaches a preset default setting or a setting selected by a user. The safety apparatus also includes an electronic controller device operatively connected to the utility and capable of disabling the utility upon receiving the signal from the sensor based upon the environmental parameter.

This U.S. patent application is a continuation-in-part (CIP) of and claims the benefit of and priority to U.S. patent application Ser. No. 12/388,637 filed on Feb. 19, 2009 which is incorporated herein by reference in its entirety.

### TECHNICAL FIELD

Certain embodiments of the present invention relate to shutting off utilities. More particularly, certain embodiments relate to automatically disabling a utility to a facility in response to a sensed abnormal condition through the use of remote sensors.

### BACKGROUND

An existing problem in the area of utilities providing, for example, natural gas or water to a facility is that, if a leak or break were to occur in a utility pipe within the facility, no practical means or method may be provided for terminating the water or natural gas flowing into the facility unless one is physically present at the time that the leak occurs. The consequences of this problem are well known to, for example, the home owner or tenant who has experienced a burst hot water tank, a broken water pipe, or a leaky natural gas pipe or valve.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention includes a safety apparatus for automatically disabling a utility of a facility. The apparatus includes at least one remote sensor that transmits a signal if a predefined environmental parameter is present, and an electronic controller device operatively connected to the utility and capable of disabling the utility upon receiving the signal based upon the environmental parameter.

Another aspect of an embodiment of the subject invention includes a fluid valve device capable of being set to at least an open state and a closed state; and a flow rate sensor device operatively connected to the fluid valve device and capable of sensing a flow rate of a fluid flowing through the apparatus and capable of outputting a signal or data of the sensed flow rate; wherein the electronic controller device is operatively connected to the flow rate sensor device to receive the signal or data of the sensed flow rate, and operatively connected to the fluid valve device and capable of commanding the fluid valve device to the closed state if the electronic controller device determines an abnormal flow condition based on the signal or data of the sensed flow rate.

Yet another aspect of an embodiment of the subject invention includes a fluid input port capable of channeling a fluid into the apparatus.

Still another aspect of an embodiment of the subject invention includes a fluid output port capable of channeling a fluid out of the apparatus.

Still yet another aspect of an embodiment of the subject invention includes a user interface device capable of being actuated by a user to reset the fluid valve device to the open state from the closed state.

A further aspect of an embodiment of the subject invention includes a user interface device capable of being actuated by a user to activate the apparatus to sense a flow rate, determine an abnormal flow condition based on the flow rate, and set the fluid valve device to the closed state in response to the determined abnormal flow condition.

Even another aspect of an embodiment of the subject invention wherein the user interface device is further capable of again being actuated by the user to deactivate the apparatus such that a fluid is able to flow freely through the apparatus without being disrupted by the apparatus.

An even further aspect of an embodiment of the subject invention includes a visible indicator capable of indicating to a user when the apparatus is activated.

Yet another aspect of an embodiment of the subject invention wherein the apparatus is adapted to accommodate a fluid including a gas.

Still another aspect of an embodiment of the subject invention includes wherein the apparatus is adapted to accommodate a fluid including water.

Still yet another aspect of an embodiment of the subject invention wherein the apparatus is adapted to accommodate a fluid including oil.

A further aspect of an embodiment of the subject invention wherein the remote sensor includes a sensing controller device, and a sensing unit, wherein the sensing controller device is operatively connected to the sensing unit.

Even another aspect of an embodiment of the subject invention wherein the remote sensor further comprises a power supply.

An even further aspect of an embodiment of the subject invention includes a safety apparatus wireless component.

Another aspect of an embodiment of the subject invention wherein the remote sensor further includes a sensing wireless component.

Yet another aspect of an embodiment of the subject invention wherein the receiving and transmitting a signal is by wireless transmission.

Still another aspect of an embodiment of the subject invention includes a user interface device capable of being actuated by a user to select at least one environmental parameter, wherein detection of the at least one environmental parameter signals the electronic controller device to disable the utility.

Still yet another aspect of an embodiment of the subject invention wherein the user interface device is further capable of again being actuated by the user to enable the utility.

A further aspect of an embodiment of the subject invention wherein the electronic controller device communicates the at least one environmental parameter to the remote sensor.

Even another aspect of an embodiment of the subject invention wherein the remote sensor transmits a signal to the electronic controller device when the at least one environmental parameter is detected by the remote sensor.

An even further aspect of an embodiment of the subject invention wherein the utility is selected from a group consisting of a furnace, an air conditioner, and a fan.

Yet another aspect of an embodiment of the subject invention wherein the environmental parameter is selected from a group consisting of a water level, a moisture level, a pollen content, smoke, carbon dioxide, carbon monoxide, natural gas, propane gas, and dust.

Still another aspect of an embodiment of the subject invention includes means for the apparatus to communicate with a motion sensor system.

Still yet another aspect of an embodiment of the subject invention includes means for the apparatus to communicate with a security system.

Another embodiment of the present invention includes a method for automatically disabling a utility of a facility, the method includes measuring an environmental factor, determining if the measured environmental factor indicates an existence of an abnormal condition, and disabling the utility if the abnormal condition is determined to exist.

Another aspect of an embodiment of the subject invention wherein the utility is selected from a group consisting of a gas, water, oil, air, electricity, and steam.

Yet another aspect of an embodiment of the subject invention wherein the facility includes one of a residential house, an apartment, and an office building.

Still another aspect of an embodiment of the subject invention wherein the abnormal condition is set by a user.

Still yet another aspect of an embodiment of the subject invention wherein the environmental factor is selected from a group consisting of a water level, a moisture level, a pollen content, smoke, carbon dioxide, carbon monoxide, natural gas, and dust.

A further aspect of an embodiment of the subject invention includes the step of: reenabling the utility if it is determined that the abnormal condition is no longer present.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a schematic diagram of an example configuration using a utility safety apparatus in a facility, in accordance with an embodiment of the present invention;

FIG. 2 illustrates a first example embodiment of a safety apparatus for automatically disabling a utility into a facility and which may be used in the configuration of FIG. 1;

FIG. 3 illustrates a second example embodiment of a safety apparatus for automatically disabling a utility into a facility and which may be used in the configuration of FIG. 1;

FIG. 4 is a flow chart of an example embodiment of a method for automatically disabling a utility into a facility using the safety apparatus of FIG. 2 or FIG. 3 in, for example, the configuration of FIG. 1;

FIG. 5 illustrates a schematic diagram of another example configuration using a utility safety apparatus in a facility, in accordance with another embodiment of the present invention;

FIG. 6 illustrates a first example embodiment of a safety apparatus for automatically disabling a utility of a facility and which may be used in the configuration of FIG. 5;

FIG. 7 illustrates an example embodiment of a sensor that may be used in the configuration of FIG. 5;

FIG. 8 illustrates a second example embodiment of a safety apparatus for automatically disabling a utility into a facility and which may be used in the configuration of FIG. 5;

FIG. 9 illustrates a third example embodiment of a safety apparatus for automatically disabling a utility into a facility and which may be used in the configuration of FIG. 5;

FIG. 10 is a flow chart of an example embodiment of a method for automatically disabling a utility of and/or into a facility using the safety apparatus of FIG. 6, FIG. 8, or FIG. 9 in, for example, the configuration of FIG. 5; and

FIG. 11 illustrates a fourth example embodiment of a safety apparatus for automatically disabling a utility into a facility and which may be used in the configuration of FIG. 5.

### DETAILED DESCRIPTION

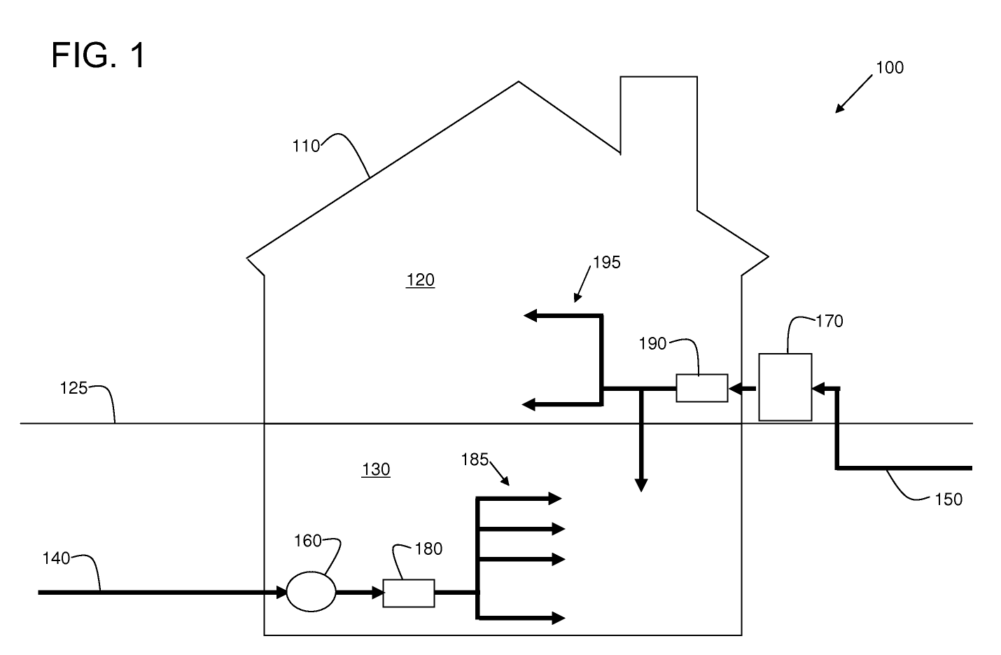

FIG. 1 illustrates a schematic diagram of an example configuration 100 using a utility safety apparatus in a facility 110, in accordance with an embodiment of the present invention. The facility 110 is a residential house having an area 120 being above the ground level 125 and a basement area 130 being below the ground level 125. The house 110 has utilities running to it including water and natural gas from a source of water 140 and a source of natural gas 150, respectively. In accordance with other configurations, the facility may be an apartment or an office building. Other types of facilities are possible as well.

The source of water 140 enters the basement area 130 and comes into a traditional water meter 160. The source of natural gas 150 comes into a traditional gas meter 170 and then enters the area 120 from an output of the gas meter 170. Traditionally, water pipes or conduits would be used to distribute water throughout the house 110. Similarly, gas pipes or conduits would be used to distribute natural gas throughout the house 110. However, in accordance with an embodiment of the present invention, a water safety apparatus 180 is connected at the output of the water meter 160 before the water is routed through pipes 185 throughout the house 110. Similarly, in accordance with an embodiment of the present invention, a gas safety apparatus 190 is connected at the output of the gas meter 170 before the gas is routed through pipes 195 throughout the house 110.

The water safety apparatus 180 functions to monitor a flow rate (e.g., in units of milliliters per second) of water into the house and detect abnormal flow conditions. Similarly, the gas safety apparatus 190 functions to monitor flow rate (e.g., in units of cubic centimeters per second) of natural gas into the house and detect abnormal flow conditions. If an abnormal flow condition is detected by the water safety apparatus 180, the water safety apparatus 180 disables the flow of water into the house. Similarly, if an abnormal flow condition is detected by the gas safety apparatus 190, the gas safety apparatus 190 disables the flow of natural gas into the house. In general, an abnormal flow condition is a flow condition that is unexpected.

For example, if a family that lives in the house 110 goes away on vacation for a week, the water safety apparatus 180 and the gas safety apparatus 190 may be activated. The water safety apparatus 180 is adapted to determine that an abnormal flow condition exists if, for example, a measured rate of flow (e.g., in ml/sec) through the apparatus 180 is substantially constant and non-zero for longer than a predefined period of time. Such an abnormal condition may be indicative of a water leak or burst water pipe somewhere within the house 110 since no one should be in the house 110 using water for such a predefined period of time. Other criterion may be used to determine an abnormal flow condition, in accordance with alternative embodiments of the present invention. For example, the water safety apparatus 180 may be adapted to determine that an abnormal flow condition exists if a measured rate of flow through the apparatus 180 simply exceeds a predefined flow rate.

Similarly, the gas safety apparatus 190 is adapted to determine that an abnormal flow condition exists if a measured rate of flow through the apparatus 190 is greater than a predefined flow rate threshold for longer than a predefined period of time. Such an abnormal condition may be indicative of a gas leak or broken gas pipe somewhere within the house 110. Such a flow of gas above the minimal needs for a gas water heater and pilot lights may indeed be indicative of a gas leak, for example. Other criterion may be used to determine an abnormal flow condition, in accordance with alternative embodiments of the present invention. For example, the gas safety apparatus 190 may be adapted to determine that an abnormal flow condition exists if a measured rate of flow through the apparatus 190 simply exceeds a predefined flow rate.

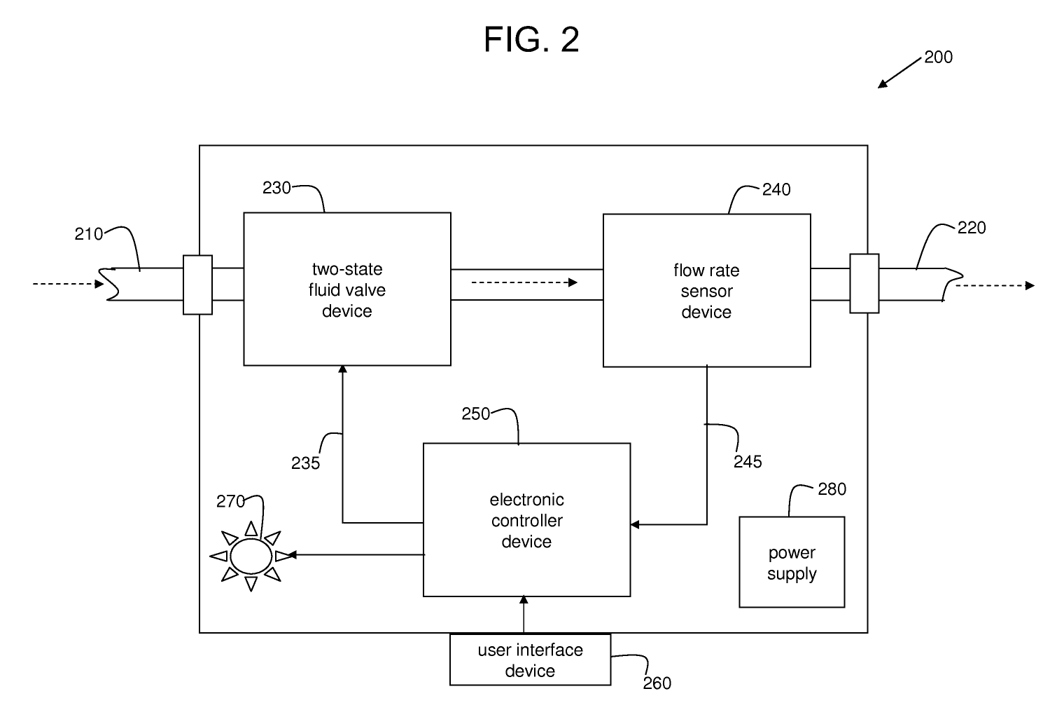

FIG. 2 illustrates a first example embodiment of a safety apparatus 200 for automatically disabling a utility into a facility and which may be used in the configuration 100 of FIG. 1. The safety apparatus 200 includes a fluid input port 210 capable of channeling a fluid into the apparatus 200, and a fluid output port 220 capable of channeling fluid out of the apparatus 200. The apparatus 200 may be adapted to accommodate a fluid such as, for example, natural gas, propane, home heating oil, or water. For example, in the configuration 100 of FIG. 1, the fluid input port 210 may be connected to the output of the water meter 160 (or gas meter 170), and the fluid output port 220 may be connected to the internal piping 185 (or 195) before branching and distributing occurs. Thus, the apparatus 200 is connected in-line with the utility coming into the facility.

The safety apparatus 200 also includes a fluid valve device 230 capable of being set at least to an open state allowing a fluid to flow through the apparatus 200 from the input port 210 to the output port 220, and a closed state preventing a fluid from flowing through the apparatus 200. Other intermediate fluid flow states may be possible as well, in accordance with other embodiments of the present invention. The safety apparatus 200 further includes a flow rate sensor device 240 operatively connected to the fluid valve device 230. The flow rate sensor device 240 is capable of sensing a flow rate of a fluid flowing through the apparatus 200, and is capable of outputting a signal or data representative of the sensed flow rate. In the apparatus 200 of FIG. 2, fluid (e.g., water or natural gas) flows into the input port 210 and then into the fluid valve device 230, then from the fluid valve device 230 (if the fluid valve device 230 is in an open state) into the flow rate sensor device 240, then out of the flow rate sensor device 240 and through the output port 220.

The safety apparatus 200 further includes an electronic controller device 250. The electronic controller device 250 is operatively connected to the flow rate sensor device 240 and the fluid valve device 230. The electronic controller device 250 is capable of receiving the signal or data representative of the sensed flow rate from the flow rate sensor device 240 via the electronic path 245. Furthermore, the electronic controller device 250 is capable of commanding the fluid valve device 230 to the closed state (non-flowing state) if the electronic controller device 250 determines the existence of an abnormal flow condition based on the signal or data representative of the sensed flow rate. Again, such an abnormal flow condition may be, for example, a substantially constant flow of gas above the minimal needs for a gas water heater and pilot lights which may be indicative of a gas leak.

In accordance with an embodiment of the present invention, the electronic controller device 250 is a microprocessor-based device that is capable of being programmed (e.g., via software instructions) to perform certain functions as described herein. In accordance with an alternative embodiment of the present invention, the electronic controller device 250 is a discrete component device that is adapted to perform certain functions as described herein. For example, the electronic control device 250 may include an electronically programmable read only memory (EPROM) component that is used as a look-up-table (LUT) to map input flow rates, received from the flow rate sensor 240 via the electronic path 245, to output command signals, sent to the fluid valve device 230 via the electronic path 235.

In accordance with an embodiment of the present invention, the two-state fluid valve device 230 has an electromagnet inside which causes the device 230 to close when a small charge or voltage Vᵥₐₗᵥₑ is applied at the electromagnet. In such an embodiment, the two-state fluid valve device 230 would open when the voltage Vᵥₐₗᵥₑ is not present at the electromagnet. The voltage Vᵥₐₗᵥₑ causes the two-state fluid valve 230 to transition from an open (flowing) state to a closed (non-flowing) state, preventing fluid from the utility source from passing through the safety apparatus 200 and on to the distributive piping or conduit of the facility. Such valve devices are well known in the art. The electronic controller device 250 is capable of providing the voltage Vᵥₐₗᵥₑ to the two-state fluid valve device 230 via the electronic path 235.

Other types of charge or voltage controlled valve devices may be possible as well. In accordance with an alternative embodiment of the present invention, the valve device 230 may operate in an opposite manner. That is, the two-state fluid valve device 230 may open when a small charge or voltage Vᵥₐₗᵥₑ is applied at the electromagnet. In such an alternative embodiment, the two-state fluid valve device 230 would close when the voltage Vᵥₐₗᵥₑ is not present at the electromagnet.

In accordance with certain embodiments of the present invention, the flow rate sensor device 240 outputs one of an analog voltage level signal indicative of the flow rate through the flow rate sensor 240, an analog square wave signal whose frequency varies linearly with flow rate through the flow rate sensor 240, and a digital data signal encoding data indicative of the flow rate through the flow rate sensor 240. Such flow rate sensors are well known in the art. Other types of signals or data indicative of flow rate may be possible as well, in accordance with various other embodiments of the present invention.

The safety apparatus 200 may also include a user interface device 260 operatively connected to the electronic controller device 250. The user interface device 260 may be capable of being actuated by a user to reset the fluid valve device 230 to the open state from the closed state via the electronic controller device 250. Also, the user interface device 260 may be capable of being actuated by a user to activate (i.e., turn on) the apparatus 200 such that the apparatus may perform the various functions described herein. Similarly, the user interface device 260 may be further capable of again being actuated by a user to deactivate the apparatus 200 such that a fluid is able to flow freely through the apparatus 200 without being disrupted by the apparatus 200, almost as if the apparatus 200 were not present in the utility line.

Furthermore, the user interface device 260 may be used to select or enter a mode or a predefined flow rate (e.g., a flow rate threshold) and/or a predefined period of time (e.g., a time interval) defining an abnormal flow condition. The user interface device 260 is located on an external portion of the apparatus 200 such that the user interface device 260 may be easily accessible by a user.

The apparatus 200 may also include a visible indicator 270 (e.g., a light emitting diode, LED) capable of indicating to a user when the apparatus is activated (i.e., turned on). The visible indicator 270 could be part of (or indicated on a display of) the user interface device 260, in accordance with an alternative embodiment of the present invention. Similarly, the apparatus 200 may further include a second visible indicator (not shown) capable of indicating to a user when the apparatus 200 is in the closed state or when the apparatus is in the open state.

Certain devices of the safety apparatus 200 may require electric power to be applied in order to function. For example, the electronic controller device 250, the flow rate sensor device 240, the user interface device 260, and the visible indicator device 270 may each require direct current (DC) electrical power to be applied (e.g., 5 VDC or 12 VDC). Therefore, the apparatus 200 includes a power source 280.

In accordance with an embodiment of the present invention, the power source 280 may include one or more batteries along with other circuitry for forming the direct current (DC) voltages with respect to a ground potential GND. In accordance with another embodiment of the present invention, the power source 280 may include a power regulator/converter that takes in alternating current (AC) from, for example, a standard 110 VAC power source and converts the AC voltage to DC voltages. Such power sources are well known in the art.

In accordance with an embodiment of the present invention, the various devices 250, 260, 270, and 280 may be mounted on a printed circuit board (PCB) which provides the various electrical interfaces between the devices. The PCB with the mounted devices, the two-state fluid valve device 230, and the flow rate sensor device 240 may be mounted substantially internally to the safety device 200 within a housing of the safety device 200.

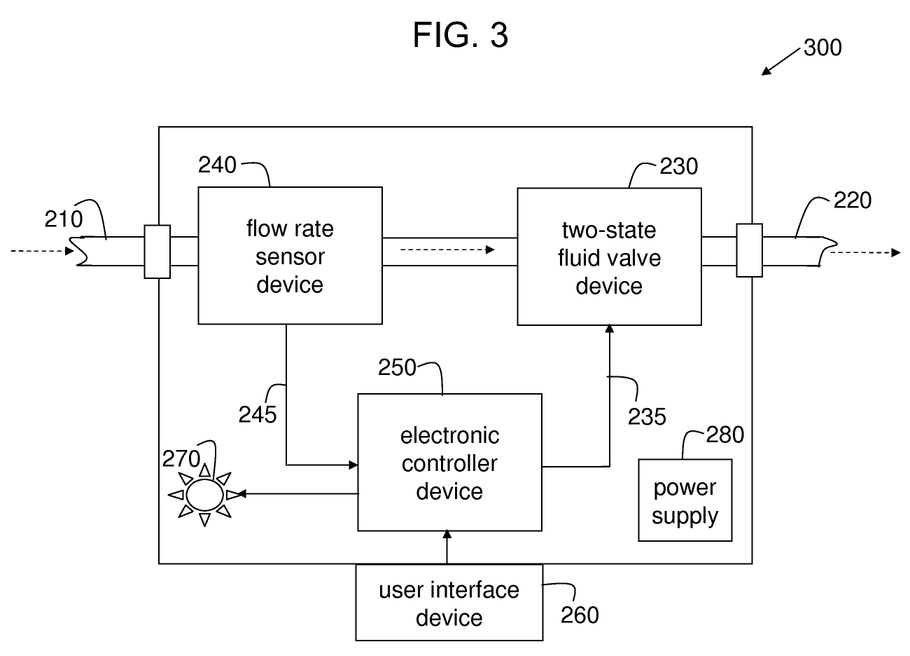

FIG. 3 illustrates a second example embodiment of a safety apparatus 300 for automatically disabling a utility into a facility and which may be used in the configuration 100 of FIG. 1. The safety apparatus 300 of FIG. 3 is very similar to and functions very similar to the safety apparatus 200 of FIG. 2, except that the safety apparatus 300 of FIG. 3 has the flow rate sensor device 240 upstream of the two-state fluid valve device 230.

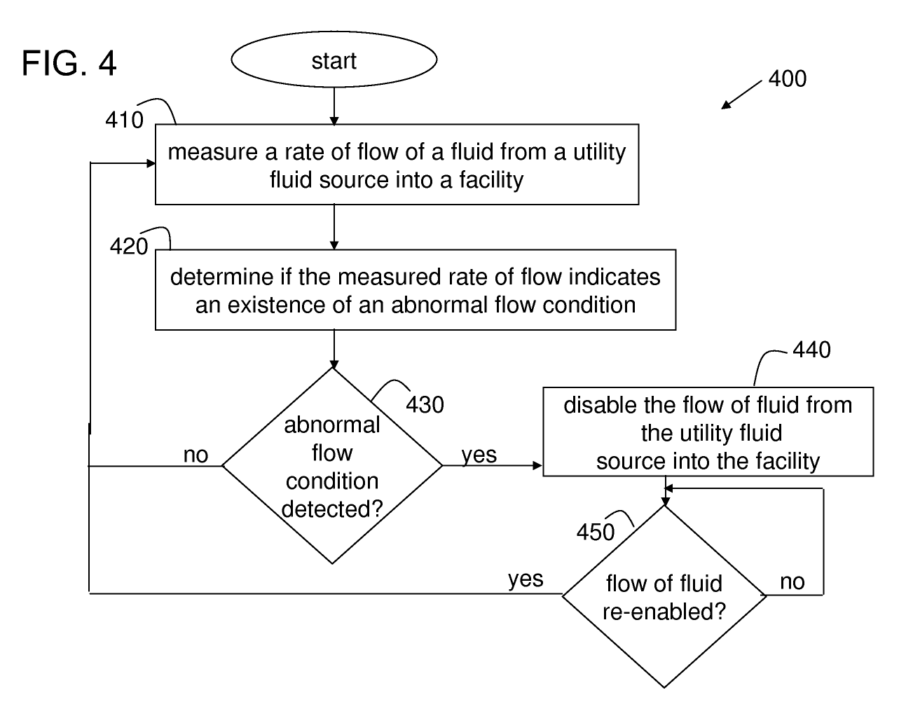

FIG. 4 is a flow chart of an example embodiment of a method 400 for automatically disabling a utility coming into a facility 110 using the safety apparatus 200 of FIG. 2 or the safety apparatus 300 of FIG. 3 in, for example, the configuration 100 of FIG. 1. In step 410, measure a rate of flow of a fluid from a utility fluid source into a facility. In step 420, determine if the measured rate of flow indicates the existence of an abnormal flow condition. In step 430, if an abnormal flow condition has been detected then, in step 440, disable the flow of fluid from the utility fluid source into the facility, otherwise, go back to step 410 and continue the method 400. If the flow of fluid from the utility fluid source into the facility has been disabled in step 440 then, in step 450, check if the flow of fluid has been re-enabled (e.g., by a user resetting a safety apparatus). If the flow of fluid has been re-enabled in step 450, then go back to step 410 and continue the method 400. Otherwise, keep checking, in step 450, if the flow of fluid has been re-enabled.

As an example, referring to FIG. 1, a family living in a residential house decides to go on vacation for a week. Before leaving, a member of the family (i.e. a user) activates a water safety apparatus 180 connected at an output of a water meter 160 in the basement 130 of the house 110, and activates another natural gas safety apparatus 190 connected at an output of a natural gas meter 170 leading into the house 110. The water safety apparatus 180 is set by the user to a “vacation” mode via a user interface 260 of the water safety apparatus 180. Similarly, the natural gas safety apparatus 190 is set by the user to a “vacation” mode via a user interface 260 of the natural gas safety apparatus 190.

For the “vacation” mode of the water safety apparatus 180, an assumption is made that almost no water should be drawn by any portion of the house 110 while the family is away on vacation and, therefore, any flow rate measured by the water safety apparatus 180 should be zero or at least very nearly zero (e.g., there may be some small amounts of water that are occasionally drawn for relatively short periods of time due to certain appliances in the house 110 such as an ice maker within a freezer).

When the “vacation” mode of the water safety apparatus 180 is selected by the user, a flow rate threshold is set within the water safety apparatus 180 to a relatively low level. Furthermore, a period of time or time interval is set within the water safety apparatus. If a leak occurs in a water pipe 185 or a water pipe 185 should break or burst while the family is away on vacation, then the rate of flow of water detected by the water safety apparatus 180 should rise above the set flow rate threshold and remain above the set flow rate threshold for at least the set period of time (i.e., an abnormal flow condition exists). The water safety apparatus 180 constantly or periodically compares the measured flow rate to the set flow rate threshold and keeps track of the time interval over which the threshold is exceeded. As a result, after the set period of time has elapsed with the detected rate of flow being above the set flow rate threshold, the water safety apparatus 180 will automatically disable itself (i.e. close a water valve) preventing additional water from being supplied to the house 110 as described herein.

Similarly, for the “vacation” mode of the natural gas safety apparatus 190, an assumption is made that a minimal amount of natural gas will be drawn by any portion of the house 110 while the family is away on vacation and, therefore, any flow rate measured by the natural gas safety apparatus 190 should be below some known level (e.g., there may be some small amount of natural gas that is constantly drawn due to minimal needs for a gas water heater and various other pilot lights).

When the “vacation” mode of the natural gas safety apparatus 190 is selected by the user, a flow rate threshold is set within the natural gas safety apparatus 190 to a relatively low level. If a leak occurs in a natural gas pipe 195 or appliance while the family is away on vacation, then the rate of flow of natural gas detected by the natural gas safety apparatus 190 should rise above the set flow rate threshold (i.e., an abnormal flow condition exists). The natural gas safety apparatus 190 constantly or periodically compares the measured flow rate to the set flow rate threshold to determine if the threshold is exceeded. As a result, with the detected rate of flow being above the set flow rate threshold, the natural gas safety apparatus 190 will automatically disable itself (i.e. close a gas valve) preventing additional natural gas from being supplied to the house 110 as described herein.

The process of comparing measured flow rates to a threshold and/or keeping track of the measured flow rate level over a time interval is accomplished by the electronic controller device 250 as described herein. The electronic controller device 250 may be a programmable microprocessor-based controller device or, for example, a discrete component controller device. The electronic controller device 250 outputs a disabling signal (e.g., a voltage level) to the fluid valve device 230 when an abnormal flow condition is detected.

When the family returns from vacation, if, for example, a water leak or a gas leak has occurred, a user will have to re-enable the appropriate disabled safety apparatus to allow water and/or natural gas to again flow into the house. Preferably, the safety apparatus is not re-enabled by a user until the problem (e.g., leak or busted pipe) has been fixed. However, the user may re-enable the safety apparatus, at least for a short period of time, in order to find the source of the problem. The safety apparatus may include a “trouble-shooting” mode, allowing a user (e.g., a plumber) to track down a leak, for example.

When the family is at home using the various appliances and water outlets of the house under normal living conditions, the safety apparatus may not be activated. That is, the safety apparatus may be turned off, allowing water and natural gas to flow into the house almost as if the safety apparatuses were not in line with the utilities. Alternatively, the safety apparatuses may be placed in an “at home” mode, where the safety apparatuses are activated and the various thresholds and/or time intervals are set to account for normal usage of water and natural gas such that the safety apparatuses are not disabled during normal usage of the utilities.

For example, the safety apparatuses may be capable of being trained during a “learning” mode by monitoring and tracking actual utility usage and determining normal or average behavior (i.e., expected usage) during a learning period. Various thresholds and/or time intervals are automatically set based on usage information acquired during the “learning” mode. Afterwards, when the safety apparatuses are placed in an “at home” mode, normal usage will not disable the safety apparatuses by closing the valves within the safety apparatuses. However, any significant deviation from normal usage, as defined by the various set thresholds and/or time intervals, will disable the safety apparatuses by closing the valves.

An example of a significant deviation from normal usage might be when a child accidentally leaves an outside water faucet on after watering a garden with a hose connected to the outside water faucet. The water safety apparatus would be able to detect this abnormal water usage and close the water valve within the water safety apparatus.

Furthermore, the safety apparatus may keep track of actual time-of-day which may also be used to determine whether valves should be closed or not. For example, normal usage during the middle of the day may be very different from normal usage during the middle of the night. Therefore, one set of thresholds and/or time intervals may be used by the safety apparatuses during the middle of the day, and another set may be used during the middle of the night. As an alternative, a safety apparatus may be set to be activated only during certain hours of the day and de-activated at certain other hours of the day. For example, a user may only desire to have the safety apparatuses activated at night when the user is sleeping (e.g., between 11:00 p.m. and 6:00 a.m.). Such activation and de-activation occurs automatically after a user sets the activated time interval via a user interface of the safety apparatus.

Other activation/de-activation periods may be set as well. For example, a user may know that his lawn sprinkler system is on every morning between 4:00 a.m. and 5:00 a.m. and, therefore, programs the water safety apparatus to be de-activated during this time. As another example, the safety apparatuses may also be programmed to keep track of not only the time of day, but also the date and/or the day of the week. A user may desire to have the safety apparatuses activated only on weekdays when the user is at work. As a further example, a user may desire to have the safety apparatuses activated only from January through March when the user is away at a winter home in Florida for these winter months.

In accordance with various other embodiments of the present invention, other types of abnormal flow conditions and modes of operation may be defined and programmed into or set into a safety apparatus. For example, upper and lower flow rate thresholds may be defined where a flow rate is considered abnormal if the flow rate falls outside of the range defined between the upper and lower thresholds. Other abnormal flow conditions and modes may be defined as well, in accordance with various other embodiments of the present invention.

In accordance with other embodiments of the present invention, a safety apparatus may be used elsewhere within a facility besides where a utility first comes into the facility. For example, a water safety apparatus may be installed in-line at the hot water output of a hot water tank within a house, thus protecting the house against any hot water line failures. Furthermore, a natural gas safety apparatus may be installed at a natural gas input to a gas furnace within a house, thus protecting the house from certain types of gas furnace failures. In accordance with another embodiment of the present invention, the safety apparatus may be a home heating oil safety apparatus that may be installed at a home heating oil input to an oil furnace within a house, thus protecting the house from certain types of oil furnace failures (e.g., if an old oil furnace gets stuck on for a prolonged period of time). Other installed locations within a house or other types of facilities are possible as well.

In accordance with a further alternative embodiment of the present invention, the safety apparatus may be operatively connected to a motion sensor system. The motion sensor system may send a signal to the electronic controller device of the safety apparatus where the signal indicates the presence or absence of detected motion. When the motion sensor system indicates to the safety apparatus that no one is home (i.e., no or insignificant motion is detected) and, however, there is an unexpected large flow of water detected, the valve within the water safety device may be automatically closed. The signal may be sent electronically, optically, or wirelessly, for example, from the motion sensor system to the safety apparatus using techniques that are well known in the art.

Similarly, in accordance with still a further alternative embodiment of the present invention, the safety apparatus may be operatively connected to a security system. The security system may send a signal to the electronic controller device of the safety apparatus where the signal indicates that the security system is activated (i.e., no one is home). When the security system indicates to the safety apparatus that no one is home (i.e., the security system is activated) and, however, there is an unexpected large flow of water detected, the valve within the water safety device may be closed. The signal may be sent electronically, optically, or wirelessly, for example, from the security system to the safety apparatus using techniques that are well known in the art.

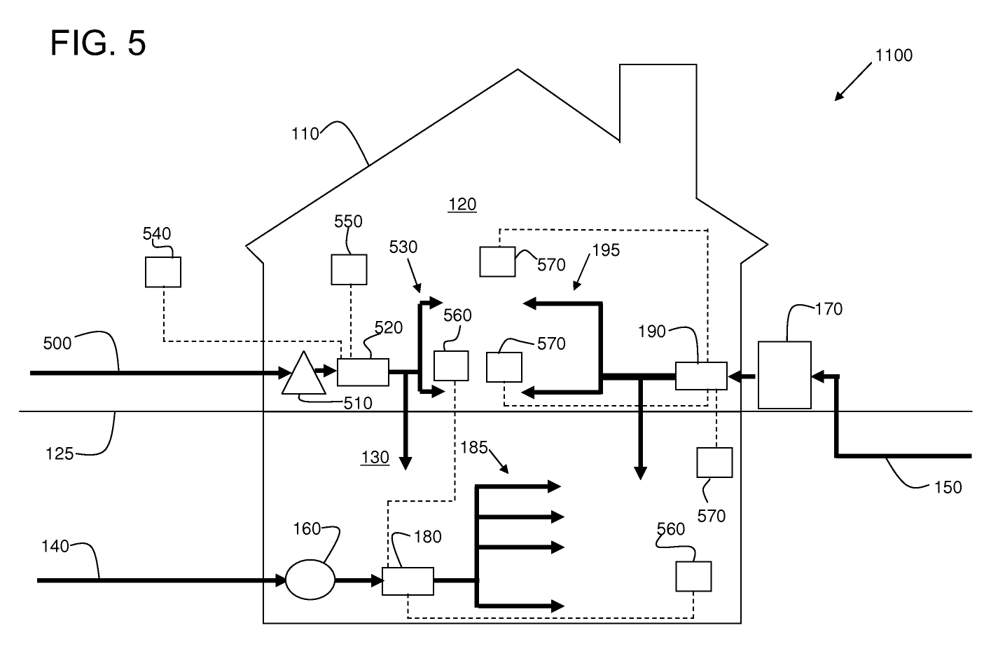

FIG. 5 illustrates a schematic diagram of an example configuration 1100, similar to the configuration 100 in FIG. 1, using a utility safety apparatus in the facility 110 in accordance with an embodiment of the present invention. Another utility running to the house 110 includes air from an air source 500. In accordance with other configurations, the facility 110 may be an apartment or an office building, as other types of facilities are possible.

The source of air 500 enters the house 110 and comes into a traditional furnace, air conditioner, or fan 510 and then enters the area 120 from an output of the furnace, air conditioner, or fan 510. Traditionally, central ventilation ducts 530 would be used to distribute air throughout the house 110. However, in accordance with an embodiment of the present invention, an air safety apparatus 520 is connected at the output of the furnace or air conditioner 510 before the air is routed through the ventilation ducts 530 throughout the house 110.

The air safety apparatus 520 functions to monitor the air quality and condition that flows through the furnace or air conditioner 510. If an abnormal air quality or condition is detected by the air safety apparatus 520, the air safety apparatus 520 disables the flow of air into the house 110. For example, if smoke created from a fire inside or outside the house 110 is detected, the air safety apparatus 520 will disable the flow of air into the house 110 so that the air is not circulated throughout the house by the furnace, air conditioner, or fan 510. If an air quality condition that may be detrimental to the inhabitant is determined, the air safety apparatus 520 will signal the furnace or air conditioner 510 in order to disable the flow of air throughout or into the house 110. Other criterion may be used to determine an abnormal air condition, in accordance with alternative embodiments of the present invention.

Additionally, an outdoor air quality sensor 540 and/or an indoor air quality sensor 550 may be connected to the air safety apparatus 520, either through physical connections, such as electrical wires, and wireless communication technology, such as infrared, Bluetooth®, transmission via radio waves, or any other wireless communication technology known by one of ordinary skill in the art. The outdoor air quality sensor 540 may be placed on the exterior of the house 110 or exteriorly of the house 110, while the indoor air quality sensor 550 may be placed interiorly of the house 110, such as in a room, basement, ceiling, etc. The purpose of the air quality sensors 540, 550 is to determine whether the outdoor air quality is detrimental to the homeowner. Examples of air quality that may be detrimental to the homeowner is a brush fire or kitchen's smoke, high concentrations of pollen that can agitate the homeowner's allergies, or high concentrations of car emissions such as carbon monoxide. When the air quality sensors 540, 550 detect unwanted or hazardous levels of air quality, the air quality sensors 540, 550 then send a signal, either wirelessly or through wires, to the air safety apparatus 520 and disables the furnace, air conditioner, or fan 510. This is turn inhibits the furnace or air conditioner 510 from continuously circulating unhealthy air into and throughout the house 110. Thereafter, if the harmful or adverse environmental condition returns to normal, the air quality sensors 540, 550 may transmit a signal to the air safety apparatus 520 and enable the furnace, air conditioner, or fan 510.

Similarly, the water (or steam) safety apparatus 180 and the gas safety apparatus 190 utilize sensors similar to the air quality sensors 540, 550. Water or moisture sensors 560 are connected to the water safety apparatus 180 wirelessly or by wires. Whenever the water or moisture sensor 560 detects water or a high level of moisture in the air, the water or moisture sensor 560 transmits a signal to the water (or steam) safety apparatus 180, which in turn disables the flow of water (or steam) into the house 110. For example, the water sensor 560 may be placed in the basement towards the floor, so that if a water pipe bursts and floods the basement, the water sensor 560 would detect the flood and send a signal to the water safety apparatus 180 to restrict the flow of water into the house 110. The water sensor 560 can also be placed in the hallways, rooms, or bathrooms in order to disable the flow of water into the house 110 whenever an excess amount of water fills a given area. The water or moisture sensor 560 may also disable the flow of water (or steam) in the house 110 whenever a certain moisture level is detected. A flood or leaking water may cause the moisture level in the house 110 to increase, at which a threshold is defined so that if the moisture level rises to this threshold, the moisture sensor 560 will signal the water (or steam) safety apparatus 180 to disable the flow of water (or steam) into the house 110.

The gas safety apparatus 190 may utilize gas sensors 570, which may be connected to the gas safety apparatus 190 either wirelessly or by wires. The gas sensors 570 may be allocated to any region of the house 110 and are able to detect the presence of gas, such as natural gas or propane gas, within a given area. The gas sensors 570 may be placed in the bedrooms, basement, and kitchen so that if a particular concentration of gas is detected by the gas sensor 570, the gas sensor 570 can signal the gas safety apparatus 190 to disable the flow of gas into the house 110. Typically, there should not be a significant amount of gas present in the house 110 at any given time. The dangers of natural gas filling the house 110, as previously discussed, is quite dangerous, and placing gas sensors 570 throughout the house 110 can substantially increase the homeowner's safety with regard to gas leaks. For example, if the homeowner is on vacation and the kitchen oven begins to leak natural gas, a single spark can ignite the gas and engulf the entire house 110. The gas sensors 570 will signal the gas safety apparatus 190, disabling the flow of gas into the house 110 long before the concentration of gas becomes too large.

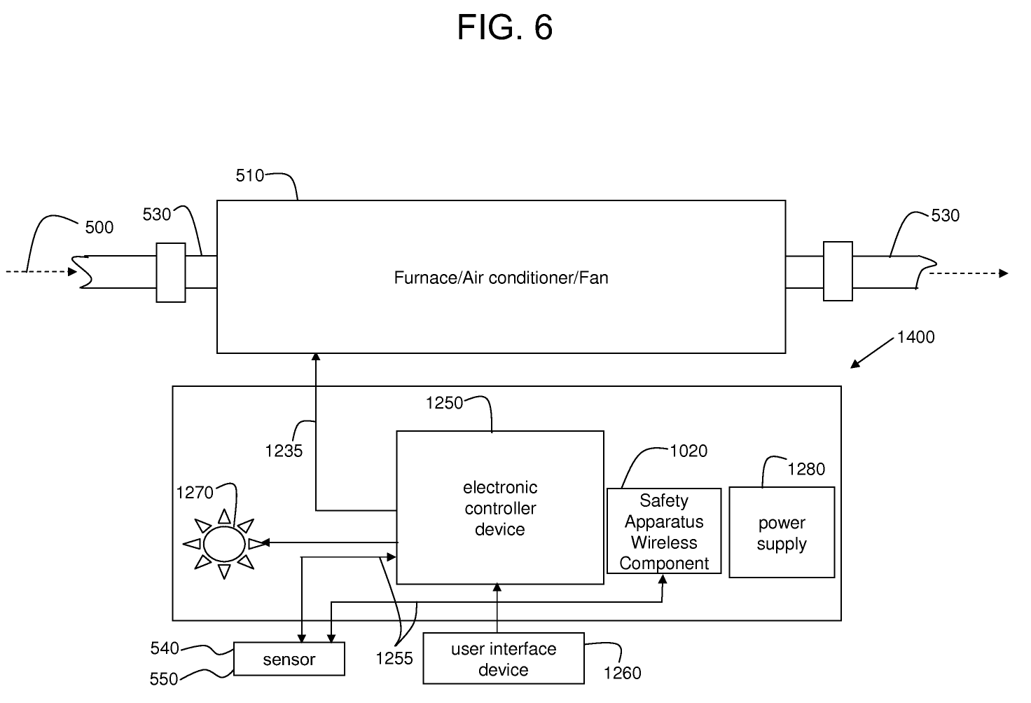

FIG. 6 illustrates an embodiment of an air safety apparatus 1400 for automatically disabling a utility of a facility and which may be used in the configuration 1100 of FIG. 5 as element 520. The air safety apparatus 1400 includes an electronic controller device 1250 and a power source 1280. The electronic controller device 1250 is operatively connected to the furnace/air conditioner/fan 510 and may enable or disable the furnace/air conditioner/fan 510. The electronic controller device 1250 is capable of receiving the signal or data transmitted by outdoor air quality sensors 540 and/or indoor air quality sensors 550 via an electronic or wireless path 1255. The air safety apparatus 1400 may be physically connected to the sensors 540, 550 through wires, or the air safety apparatus 1400 may include a safety apparatus wireless component 1020 that allows the air safety apparatus 1400 to communicate with the sensors 540, 550 utilizing wireless technology, such as transmissions via radio waves. Furthermore, the electronic controller device 1250 is capable of commanding the furnace/air conditioner/fan 510 to the closed state (non-operating state) if the electronic controller device 1250 determines the existence of an abnormal air quality condition based on the signal or data transmitted by the sensors 540, 550. Again, such an abnormal air quality condition may be, for example, smoke resulting from a brush fire or kitchen accident or the amount of pollen in the air.

In accordance with an embodiment of the present invention, the electronic controller device 1250 is a microprocessor-based device that is capable of being programmed (e.g., via software instructions) to perform certain functions as described herein. In accordance with an alternative embodiment of the present invention, the electronic controller device 1250 is a discrete component device that is adapted to perform certain functions as described herein. For example, the electronic control device 1250 may include an electronically programmable read only memory (EPROM) component that is used as a look-up-table (LUT) to map air quality, received from the outdoor air quality sensors 540 and the indoor air quality sensor 550 via an electronic or wireless path 1255, to output command signals, sent to the furnace/air conditioner/fan 510 via an electronic path 1235.

The safety apparatus 1400 may also include a user interface device 1260 operatively connected to the electronic controller device 1250. The user interface device 1260 may be capable of being actuated by a user to reset the furnace/air conditioner/fan 510 to an operating state from the non-operating state via the electronic controller device 1250. Also, the user interface device 1260 may be capable of being actuated by a user to activate (i.e., turn on) the apparatus 1400 such that the apparatus may perform the various functions described herein. Additionally, the user interface device 1260 may include preset default settings regarding the specifications of when the safety apparatus 1400 disables the furnace/air conditioner/fan 510. The user interface device 1260 may also allow the user to select certain options regarding the specifications of when the safety apparatus 1400 disables the furnace/air conditioner/fan 510. For example, a user may utilize the user interface device 1260 to select a particular pollen percentage level, smog content, carbon dioxide/monoxide measurement, or any other air quality parameters known by persons of ordinary skill in the art before disabling the furnace/air conditioner/fan 510. The electronic controller device 1250 may then transmit the preset default settings or selected parameters to the sensors 540, 550. If the sensors 540, 550 detect an air quality parameter that has met the preset default setting or the user's selected limit, the sensors 540, 550 may communicate a signal to the air safety apparatus 1400, disabling the furnace/air conditioner/fan 510. In another embodiment of the present invention, the sensors 540, 550 may also continuously transmit environmental data to the air safety apparatus 1400, wherein the air safety apparatus then determines whether the received environmental data necessitates disabling the furnace/air conditioner/fan 510. If the environmental data is within the range or parameters of the default settings or selected by the user, the air safety apparatus 1400 will then disable the furnace/air conditioner/fan 510.

Furthermore, the user interface device 1260 may be used to select or enter a mode or a predefined air flow rate (e.g., a flow rate threshold) and/or a predefined period of time (e.g., a time interval) defining an abnormal air quality condition. The user interface device 1260 is located on an external portion of the apparatus 1400 such that the user interface device 1260 may be easily accessible by a user.

The apparatus 1400 may also include a visible indicator 1270 (e.g., a light emitting diode, LED) capable of indicating to a user when the apparatus 1400 is activated (i.e., turned on). The visible indicator 1270 could be a part of (or indicated on a display of) the user interface device 1260, in accordance with an alternative embodiment of the present invention. Similarly, the apparatus 1400 may further include a second visible indicator (not shown) capable of indicating to a user when the apparatus 1400 is in the non-operating state or when the apparatus is in the operating state.

Certain devices of the safety apparatus 1400 may require electric power to be applied in order to function. For example, the electronic controller device 1250, the sensors 540, 550, the user interface device 1260, and the visible indicator device 1270 may each require direct current (DC) electrical power to be applied (e.g., 5VDC or 12VDC). Therefore, the apparatus 1400 includes a power source 1280.

In accordance with an embodiment of the present invention, the power source 1280 may include one or more batteries along with other circuitry for forming the direct current (DC) voltages with respect to a ground potential GND. In accordance with another embodiment of the present invention, the power source 1280 may include a power regulator/converter that takes in alternating current (AC) from, for example, a standard 110 VAC power source and converts the AC voltage to DC voltages. Such power sources are well known in the art.

In accordance with an embodiment of the present invention, the various devices 1250, 1260, 1270, and 1280 may be mounted on a printed circuit board (PCB) which provides the various electrical interfaces between the devices. The PCB with the mounted devices may be mounted substantially internally to the safety device 1100 within a housing of the safety device 1400.

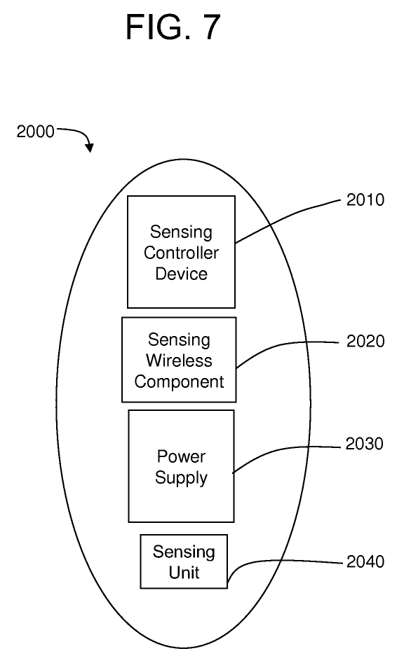

FIG. 7 illustrates an embodiment of a sensor 2000 similar to sensors 540, 550, 560, and 570 for illustrative purposes only, and not to limit the same, which may sense fluctuations in air quality, water and moisture concentration, and/or natural gas concentrations. The sensor 2000 may include a sensing controller device 2010, similar to the electronic controller device 1250, and a sensing unit 2040. The sensor 2000 may also include a sensing wireless component 2020 or utilize wires to communicate with a safety apparatus. The sensing controller device 2010 may be a microprocessor-based device that is capable of being programmed (e.g., via software instructions) to perform certain functions as described herein. For example, the sensing controller device 2010 may include an electronically programmable read only memory (EPROM) component that is used to receive signals from the sensing unit 2040, and then to output command signals, by wires or by the sensing wireless component 2020, to corresponding safety apparatuses such as the air safety apparatus 520, the water safety apparatus 180, and/or the gas safety apparatus 190 of configuration 1100 in FIG. 5. The sensor 2000 may also include a power supply 2030 that supplies power to the sensing controller device 2010, the sensing wireless component 2020, and the sensing unit 2040, wherein the power supply 2030 is similar to the power supply 1280.

In accordance with an embodiment of the present invention, the various devices 2010, 2020, 2030, and 2040 may be mounted on a printed circuit board (PCB) which provides the various electrical interfaces between the devices. The PCB with the mounted devices may be mounted substantially internally of a housing of the sensor 2000. The sensor 2000 may also be attached to a surface such as a side of a house, a wall, or a basement by means of attachment that include sticky tape, hooks, nails, hooks and loops, or any other means of attachment known by one of ordinary skill in the art.

In accordance with an embodiment of the present invention, the sensing unit 2040 may be selected with sound engineering depending on its application, whether the sensing unit is utilized to sense water, moisture, air quality, or gas such as natural or propane gas. The following examples are for illustrative purposes and not to limit the same, a water or moisture sensor may utilize infrared, non-contact infrared temperature measurements, or impendence moisture technology to detect water molecules in an environment. An air quality sensor may utilize scattered light intensity, polarization degree, ionization detectors, or photoelectric detectors to determine whether the air quality is satisfactory to enter or circulate throughout the house 110. Natural gas sensors are well known in the art and when a Lower Explosive Limit (LEL), which is the lowest amount of gas that will cause an explosion, is reached, the sensing unit 2040 sends an electronic signal to the sensing controller device 2010 that then transmits a signal to a natural gas safety apparatus that then disables the flow of natural gas into the house 110. Similarly, when a water, moisture, or air quality sensor detects an excess of harmful or damaging amount of water, moisture, or air quality, the sensing unit 2040 sends an electronic signal to the sensing controller device 2010 that then transmits a signal to a corresponding safety apparatus that then disables the corresponding utility and/or furnace, air conditioner, or fan.

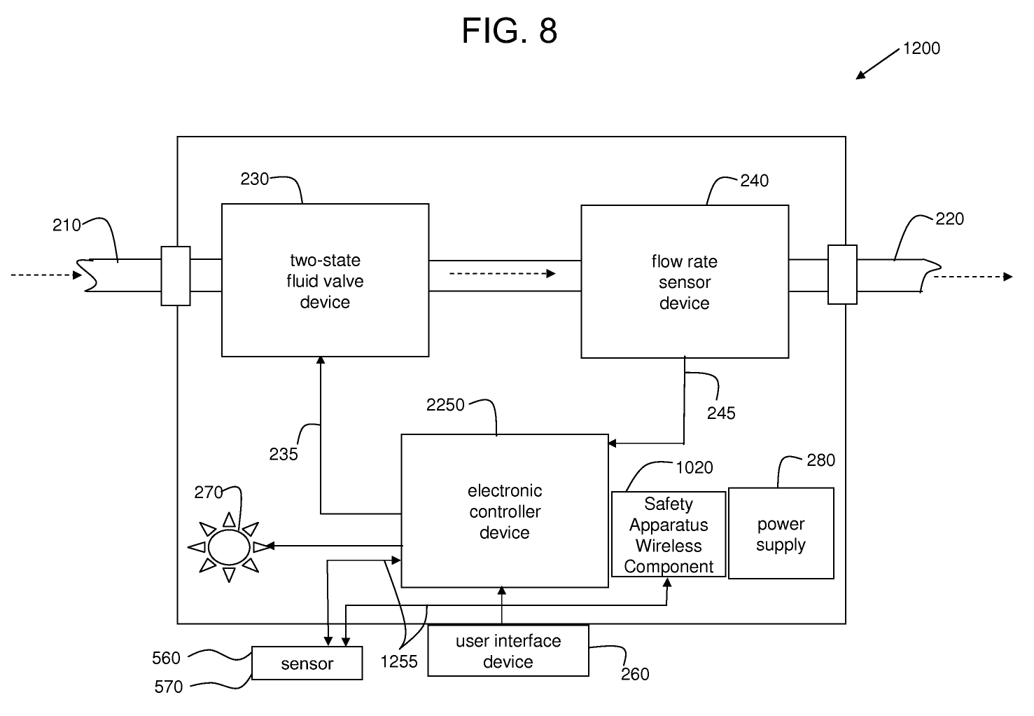

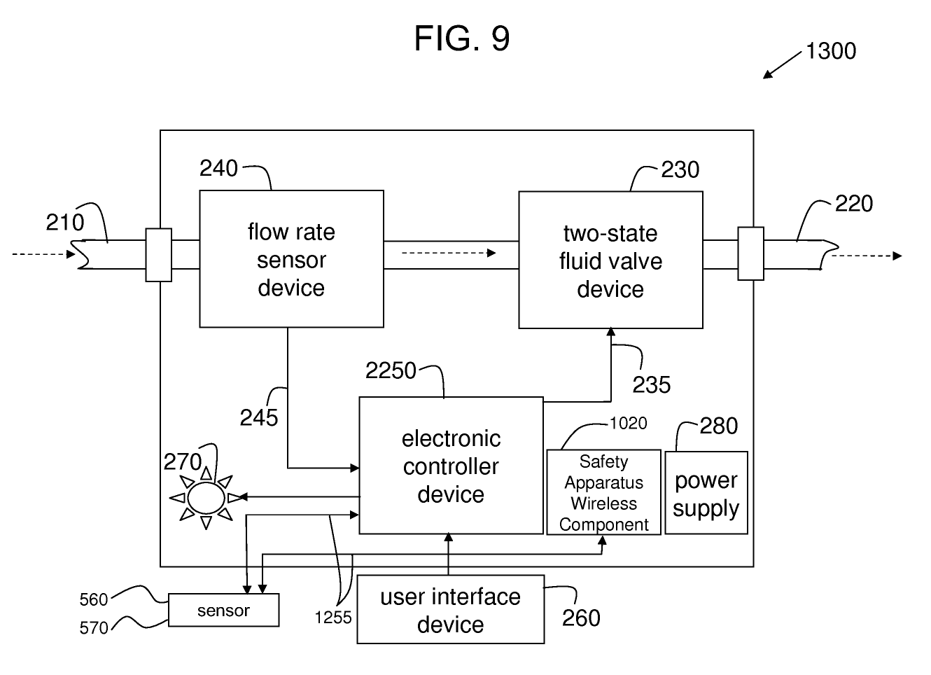

FIGS. 8 and 9 illustrate another example embodiment of safety apparatuses 1200 and 1300 for automatically disabling a utility into a facility and which may be used in the configuration 1100 of FIG. 5. The safety apparatuses 1200 and 1300 include the majority of the elements shown in FIG. 2 and FIG. 3, respectively, with the inclusion of a sensor 560, 570, depending on the type of fluid moving through the safety apparatuses 1200 and 1300, an electronic controller device 2250, which is similar to an electronic controller device 250 of FIG. 2 and FIG. 3 and an electronic controller device 1250 of FIG. 6, and a sensor electronic or wireless path 1255. The safety apparatuses 1200 and 1300 may also include the safety apparatus wireless component 1020, as described above. Additionally, the electronic controller device 2250 is capable of receiving the signal or data transmitted by sensors 560 and 570 via the electronic or wireless path 1255. Moreover, the safety apparatuses 1200 and 1300 may also receive a signal or data transmitted by the outdoor air quality sensors 540 and/or the indoor air quality sensors 550 and disable the utility into the facility. For example, if a fire is detected by either the outdoor air quality sensors 540 or the indoor air quality sensors 550, the safety apparatuses 1200 and 1300 may then disable the gas utility to prohibit the possibility of further damage that may be caused by ignited gas.

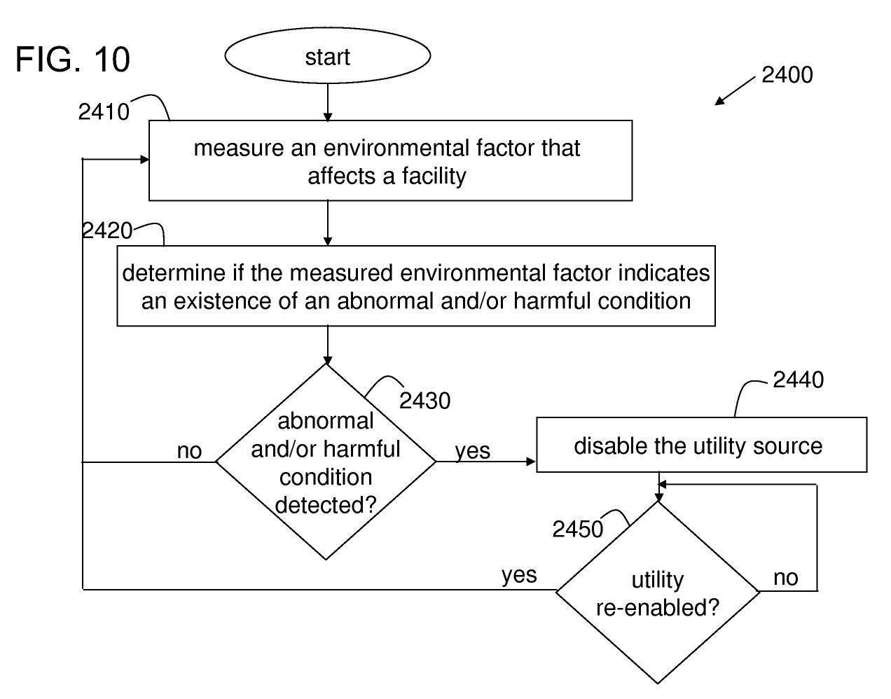

FIG. 10 is a flow chart of an example embodiment of a method 2400 for automatically disabling a utility, which may include the water line, natural gas line, furnace, air conditioner, and fan, coming into a facility 110 using the safety apparatus 1400 of FIG. 6, the safety apparatus 1200 of FIG. 8, or the safety apparatus 1300 of FIG. 9 in, for example, the configuration 1100 of FIG. 5. In step 2410, measure an environmental factor that affects a facility. In step 2420, determine if the measured environmental factor indicates an existence of an abnormal and/or harmful condition. In step 2430, if an abnormal and/or harmful condition is detected then, in step 2440, disable the utility source, otherwise, go back to step 2410 and continue the method 2400. If the utility has been disabled in step 2440 then, in step 2450, check if the utility has been re-enabled (e.g., by a user resetting a safety apparatus). If the utility has been re-enabled in step 2450, then go back to step 2410 and continue the method 2400. Otherwise, keep checking, in step 2450, if the utility has been re-enabled.

In accordance with a further alternative embodiment of the present invention, the safety apparatus 1200, 1300, 1400 may be operatively connected to a motion sensor system (not shown). The motion sensor system may send a signal to the electronic controller device 1250, 2250 of the safety apparatus 1200, 1300, 1400 where the signal indicates the presence or absence of detected motion. When the motion sensor system indicates to the safety apparatus 1200, 1300, 1400 that no one is home (i.e., no or insignificant motion is detected) and, for example, there is an unexpected large flow of water or unwanted air quality detected, the valve within the fluid safety device may be automatically closed or the furnace/air conditioner/fan 510 turned off. The signal may be sent electronically, optically, or wirelessly, for example, from the motion sensor system to the safety apparatus 1200, 1300, 1400 using techniques that are well known in the art.

Similarly, in accordance with still a further alternative embodiment of the present invention, the safety apparatus 1200, 1300, 1400 may be operatively connected to a security system (not shown). The security system may send a signal to the electronic controller device 1250, 2250 of the safety apparatus 1200, 1300, 1400 where the signal indicates that the security system is activated (i.e., no one is home). When the security system indicates to the safety apparatus 1200, 1300, 1400 that no one is home (i.e., the security system is activated) and, for example, there is an unexpected large flow of water or unwanted air quality detected, the valve within the fluid safety device may be automatically closed or the furnace/air conditioner/fan 510 turned off. The signal may be sent electronically, optically, or wirelessly, for example, from the security system to the safety apparatus 1200, 1300, 1400 using techniques that are well known in the art.

In accordance with another alternative embodiment of the present invention, the safety apparatus 1200, 1300, 1400 may be operatively connected to a transmitter that may transmit a signal to the user when a default condition or a setting selected by the user is detected by the safety apparatus 1200, 1300, 1400, through wired or wirelessly means. The transmitted signal may be received by the user by wireless means such as cell phone towers, short and long range radio transmissions, satellites, and any other means known by one of ordinary skill in the art. The transmitted signal may also be received by the user through wired means such as through a local area network (LAN), which sends its communications through signals carried by a coaxial cable or twisted pair wiring, fiber optic cables, phone lines, and any other means known by one of ordinary skill in the art. The user may receive the signal transmitted by the safety apparatus 1200, 1300, 1400 as an electronic mail, a text message, a HyperText Markup Language (HTML) website, or any other form of electronic transmission selected with sound engineering.

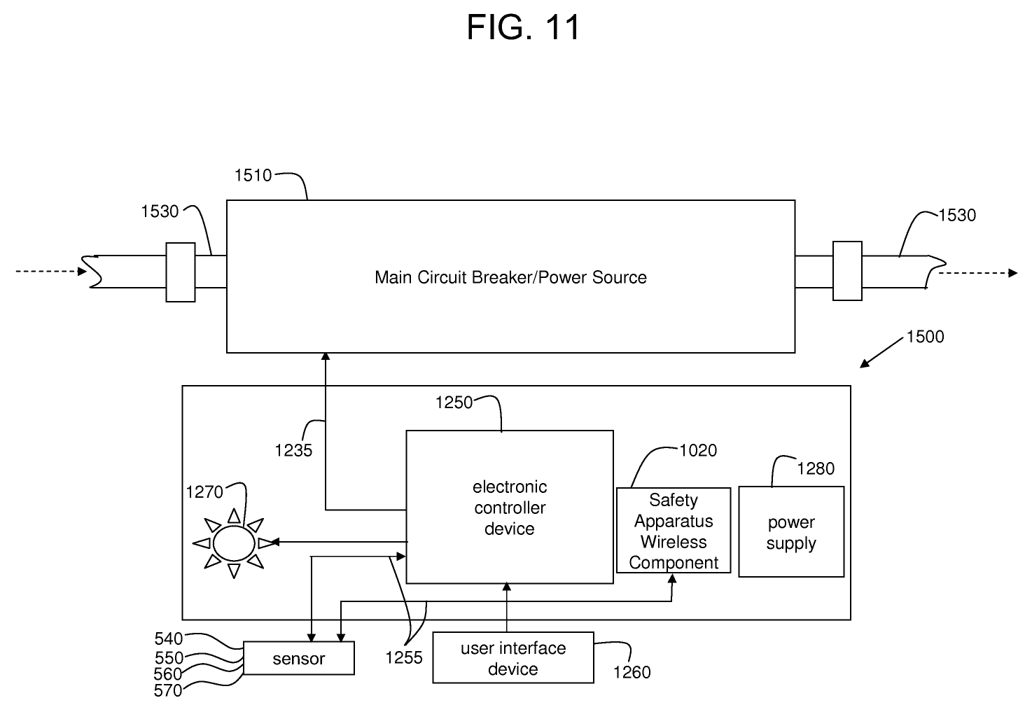

FIG. 11 illustrates another example embodiment of electrical safety apparatus 1500 for automatically disabling a utility into a facility and which may be used in the configuration 1100 of FIG. 5. The electrical safety apparatus 1500 may be operatively connected to a main circuit breaker/power source 1510 of a facility along power/electrical lines 1530, which may be used in a configuration similar to that of safety apparatus 1400. With the inclusion of a sensor 540, 550, 560, 570, the electrical safety apparatus 1500 is used to disable the main circuit breaker/power source 1510. The electrical safety apparatus 1500 is similar to the safety apparatus 1400 and may include the majority of the elements shown in FIG. 6, the electronic controller device 1250 and the sensor electronic or wireless path 1255. The electrical safety apparatus 1500 may also include the safety apparatus wireless component 1020, as described above. Additionally, the electronic controller device 1250 is capable of receiving the signal or data transmitted by sensors 560 and 570 via the electronic or wireless path 1255. Moreover, the safety apparatus 1500 may also receive a signal or data transmitted by the outdoor air quality sensors 540 and/or the indoor air quality sensors 550 and disable the electrical utility into the facility. When a power level, voltage level, and/or current level reaches the threshold selected by the user or default level, the electrical safety apparatus 1500 will then disable, or render non-operative, the main circuit breaker/power source 1510 of a facility.

In summary, a safety apparatus for automatically disabling a utility of a facility is disclosed. The safety apparatus includes at least one remote sensor that transmits a signal if an environmental parameter reaches a preset default setting or a setting selected by a user. The safety apparatus also includes an electronic controller device operatively connected to the utility and capable of disabling the utility upon receiving the signal from the sensor based upon the environmental parameter.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A safety apparatus for automatically disabling a utility of a facility, said apparatus comprising:
at least one remote sensor that transmits a signal if an environmental parameter is present; and
an electronic controller device operatively connected to said utility and capable of disabling said utility upon receiving said signal based upon said environmental parameter.

2. The apparatus of claim 2 further comprising:
a fluid valve device capable of being set to at least an open state and a closed state; and
a flow rate sensor device operatively connected to said fluid valve device and capable of sensing a flow rate of a fluid flowing through said apparatus and capable of outputting a signal or data of said sensed flow rate,
wherein said electronic controller device is operatively connected to said flow rate sensor device to receive said signal or data of said sensed flow rate, and operatively connected to said fluid valve device and capable of commanding said fluid valve device to said closed state if said electronic controller device determines an abnormal flow condition based on said signal or data of said sensed flow rate.

3. The apparatus of claim 2 further comprising a fluid input port capable of channeling a fluid into said apparatus.

4. The apparatus of claim 2 further comprising a fluid output port capable of channeling a fluid out of said apparatus.

5. The apparatus of claim 2 further comprising a user interface device capable of being actuated by a user to reset said fluid valve device to said open state from said closed state.

6. The apparatus of claim 2 further comprising a user interface device capable of being actuated by a user to activate said apparatus to sense a flow rate, determine an abnormal flow condition based on said flow rate, and set said fluid valve device to said closed state in response to said determined abnormal flow condition.

7. The apparatus of claim 6 wherein said user interface device is further capable of again being actuated by said user to deactivate said apparatus such that a fluid is able to flow freely through said apparatus without being disrupted by said apparatus.

8. The apparatus of claim 6 further comprising a visible indicator capable of indicating to a user when said apparatus is activated.

9. The apparatus of claim 2 wherein said apparatus is adapted to accommodate a fluid including a gas.

10. The apparatus of claim 2 wherein said apparatus is adapted to accommodate a fluid including water.

11. The apparatus of claim 2 wherein said apparatus is adapted to accommodate a fluid including oil.

12. The apparatus of claim 1 wherein said remote sensor comprises:
a sensing controller device; and
a sensing unit,
wherein said sensing controller device is operatively connected to said sensing unit.

13. The apparatus of claim 12 wherein said remote sensor further comprises a power supply.

14. The apparatus of claim 1 further comprising a safety apparatus wireless component.

15. The apparatus of claim 14 wherein said remote sensor further comprises a sensing wireless component.

16. The apparatus of claim 15 wherein said receiving and transmitting a signal is by wireless transmission.

17. The apparatus of claim 1 further comprising a user interface device capable of being actuated by a user to select at least one environmental parameter,
wherein detection of said at least one environmental parameter signals the electronic controller device to disable said utility.

18. The apparatus of claim 17 wherein said user interface device is further capable of again being actuated by said user to enable said utility.

19. The apparatus of claim 17 wherein said electronic controller device communicates said at least one environmental parameter to said remote sensor.

20. The apparatus of claim 19 wherein said remote sensor transmits a signal to said electronic controller device when said at least one environmental parameter is detected by said remote sensor.

21. The apparatus of claim 1 wherein said utility is selected from a group consisting of a furnace, an air conditioner, and a fan.

22. The apparatus of claim 1 wherein said environmental parameter is selected from a group consisting of a water level, a moisture level, a pollen content, smoke, carbon dioxide, carbon monoxide, natural gas, propane gas, and dust.

23. The apparatus of claim 1 further comprising means for said apparatus to communicate with a motion sensor system.

24. The apparatus of claim 1 further comprising means for said apparatus to communicate with a security system.

25. The apparatus of claim 1 wherein said environmental parameter is set by a user.

26. A method for automatically disabling a utility of a facility, said method comprising:
measuring an environmental factor;
determining if said measured environmental factor indicates an existence of an abnormal condition; and
disabling said utility if said abnormal condition is determined to exist.

27. The method of claim 26 wherein said utility is selected from a group consisting of gas, water, oil, air, electricity, and steam.

28. The method of claim 26 wherein said facility comprises one of a residential house, an apartment, and an office building.

29. The method of claim 26 wherein said abnormal condition is set by a user.

30. The method of claim 26 wherein said environmental factor is selected from a group consisting of a water level, a moisture level, a pollen content, smoke, carbon dioxide, carbon monoxide, natural gas, and dust.

31. The method of claim 26 further comprises the step of:
reenabling said utility if it is determined that said abnormal condition is no longer present.
